(19) United States
(12) Patent Application Publication
(10) Pub. No.: US 2005/0198205 A1
(43) Pub. Date: Sep. 8, 2005

(54) Data acquisition system and method for using the same

(76) Inventor: James Roach, Southlake, TX (US)

Correspondence Address: VINSON & ELKINS L.L.P., 1001 FANNIN STREET, 2300 FIRST CITY TOWER, HOUSTON, TX, 77002-6760, US

(21) Appl. No.: 10/766,247

(22) Filed: Jan. 28, 2004

(51) Int. Cl. G06F 15/16

(52) U.S. Cl. 709/219

(57) ABSTRACT

A method for remotely collecting data from a dealer management system includes identifying a dealer management system that is coupled to a secure data access port. The secure data access port is also coupled to a public network, and the dealer management system is coupled to at least one client device and is operable to process dealer initiated transactions from the client device. A remote system remotely connects to the dealer management system using the public network. The remote connection is a public connection established through the secure data access port, and the secure data access port is operable to pass remote transactions received from the remote system to the dealer management system. A remote transaction is forwarded from the remote system to the dealer management system. The remote transaction includes a request for stored data and is given a priority level by the dealer management system that is similar to client initiated transactions. The requested data is received at the remote system from the dealer management system. In another aspect of the present invention, a system includes a secure data access port coupled to a public network and a dealer management system. The dealer management system is coupled to at least one client device and is operable to process dealer initiated transactions from the client device. The secure data access port is cooperatively operable with the dealer management system to accept a remote connection from a remote system. The remote connection is established with the secure data access port, and the secure data access port is operable to pass remote transactions received from the remote system to the dealer management system. The secure data access port is operative to receive a remote transaction from the remote system and forward the remote transaction to the dealer management system. The remote transaction includes a request for stored data and is given a priority level by the dealer management system that is similar to client initiated transactions. The secure data access port is operable to forward the requested data received from the dealer management system to the remote system.

### BACKGROUND OF THE INVENTION

1. Field of the Invention

This invention relates generally to a data acquisition system, and, more particularly, to a system for remotely accessing certain databases and extracting data to provide for real-time report updating

2. Description of the Related Art

Certain databases are configured to be accessible by client devices, but are not designed for remote access. These types of databases are usually isolated from public networks, such as the Internet, to prevent unauthorized access to stored data. Moreover, these databases are typically coupled to one or more dedicated client terminals, computers, or other devices that provide access to the stored data from, for example, a local area network. One example of such a system is an automobile dealership's dealer management system (‘DMS’).

Most automobile dealerships rely on a DMS or similar system to store and manage data related to inventory, sales, parts, insurance, financing, and other dealership interests. Many of these systems in use today operate using a Unix-based Pick database system. A number of different providers supply these types of database solutions for automobile dealerships. These providers include, for example, ADP, Reynolds and Reynolds, UCS, Dealer Solutions, AS400 Based Systems, and the like. Many of the dealership implementations in use today are legacy systems and are not designed for remote access.

Referring to FIG. 1, an illustrative DMS 4 is shown. In this example, the DMS 4 is operating in an automobile dealership (e.g., Ford, Chevrolet, BMW, etc.) and includes a plurality of client terminals 8 dedicated to the DMS 4. The terminals 8 are coupled to the DMS 4 over communication links 12. The communication links 12 may include any number of different hardware and protocol configurations. Although the terminals 8 are illustrated as being directly coupled to the DMS 4 it should be appreciated that intermediate devices, such as switches, repeaters, hubs, computers, and other devices, may be placed along the communication link 12 between the terminals 8 and the DMS 4. The system is traditionally configured to provide access to the DMS through serial ports, or in some cases, over a local area network TCP/IP connection. In one embodiment, the terminals 8 are directly coupled to the DMS 4 using coaxial cable and data is transmitted using the serial RS-232 protocol. In another embodiment, the DMS 4 is stored in a remote facility, and the terminals 8 communicate with the DMS 4 over a wide area network (WAN) via a virtual private network (VPN) connection using the TCP/IP protocol.

In use, the DMS 4 allows salespersons, management, and other authorized users to access stored dealership data. For example, a salesperson may use the DMS 4 to determine whether the dealership has a certain vehicle in its existing inventory. To accomplish this, the salesperson accesses the stored inventory data using an available terminal 8 in the dealership. Normally, a number of terminals 8 are strategically placed in a dealership. Often, each salesperson's office includes a connected terminal 8. As described above, however, the terminals 8 are ordinarily separated from the dealership's Internet connected network.

Access to the DMS 4 is usually pass-code protected. In this case, the salesperson enters a pass-code, such as a user ID and password, to gain access to the DMS 4. Once access has been granted, the salesperson is able to run queries and reports on the dealership's inventory data to search for a particular vehicle of interest. For example, the salesperson may search the inventory for vehicles matching a certain color, engine type, interior, and the like. In a similar manner, a service employee may use the DMS 4 to determine whether the service department has a particular part in its parts inventory. The dealerships management personnel may use the DMS 4 to track the number of warranty claims submitted over a given period. In short, the DMS 4 is an essential tool for dealership management and operations.

Most dealership employees are provided restricted access to the data stored in the DMS 4. As an example, an employee may only be permitted access to dealership data that is relevant to their particular task or function. This may be accomplished by associating security attributes to the employee's pass-code. For example, a salesperson's user ID may be configured in the DMS 4 to only allow access to certain data, such as dealership inventory data. Likewise, a service employee's user ID may be configured in the DMS 4 to only allow access to parts inventory data and service work-order data. The general manager of the dealership, on the other hand, is usually given complete access to all stored dealership data.

A vast majority of automobile dealerships contract with vendors (i.e., service providers) to provide value added services to the dealership and/or its customers. These vendor services may include warranty services, inventory management, insurance services, financing services, after-market parts services, and the like. A number of known vendors include CNA Insurance, Universal Underwriters Group, JD Power & Associates, Carousel Insurance, Chrome Data, Cobalt Group, Southwest Reinsurance, and Protracking.

To provide their services, a majority of vendors rely on dealership data stored in the DMS 4. In one case, the vendor extracts certain data from the DMS 4 and performs some type of value added analysis on the data. Cobalt, for example, advertises a Customer Management Package that automatically tracks where dealership prospects are coming from, so that a dealership may focus its advertising and marketing resources on this particular market group. The Customer Management Package also measures the return on the dealership's marketing investment. Cobalt provides this service by downloading and analyzing customer data and marketing data stored in a dealership's DMS 4. In a similar manner, other vendors, such as the vendors identified above, provide their value added services using certain dealership data stored in the DMS 4.

These vendors generally contract their services to numerous dealerships dispersed across the country. Presently, there are approximately twenty-four thousand automobile dealerships in the United States. For this and other reasons discussed below, accessing stored data in a dealership's DMS 4 has proven to be a challenging endeavor for vendors and other users that are not connected to the DMS 4 from a client device. The problem is exacerbated by the fact that the data in the DMS 4 is continually changing, thus requiring vendors to repeatedly access the stored data to ensure that their services are based upon reasonably current data.

In FIG. 1, the generally accepted approach for vendors to access the DMS 4 is through a dial-in access port 12 that is connected to the DMS 4. In most systems, the dial-in access port 12 is a DMS maintenance port that is intended to allow the DMS 4 provider to remotely dial in to the DMS 4 for providing system support, updates, software patches, and the like. In this example, a remote system 16 is shown accessing the dial-in access port 12 over a dial-in connection 20. The remote system 16 may be any electronic system or device (e.g., computer, server, etc.) capable of communicating with the DMS 4 through the dial-in access port 12. The dial-in access port 12 is connected to a conventional telephone line, and the dial-in connection 20 is established using conventional dial-up telephone service, as is well known. Occasionally this port is provided over IP connection such as in the case of a virtual private network connection.

Generally, a vendor is given a pass-code from the dealership for accessing the DMS 4. As described above, the pass-code is usually restricted allowing the vendor only limited access to certain dealer data stored in the DMS 4. For example, Cobalt's pass-code may be limited to customer data and marketing data stored in the DMS 4, while other vendors may have their pass-code restricted to other types of dealer data.

In FIG. 2, a flowchart 24 is shown illustrating a typical approach used by vendors for accessing dealer data stored in the DMS 4. At block 28, a vendor's remote system 16 dials up the dial-in access port 12 to remotely access the DMS 4. Once connected, the vendor enters its pass-code previously given by the dealership. If valid, the pass-code grants the vendor restricted access to the DMS 4.

In most if not all dealership systems, when connected through the dial-in access port 12, the remote system 16 is unable to directly extract data from the DMS 4. Instead, the remote system 16 must progress through a series of steps to make available the desired data, capture the data, and format the data so that it may be saved in a reusable format.

At block 32, the remote system 16 executes a script or series of commands using terminal emulation or other methods to generate DMS reports that include the desired data. For example, Cobalt may remotely dial in to the DMS 4 through the dial-in access port 12 and generate reports that include customer data, such as a customer's home address, occupation, phone numbers, annual salary, and the like. These reports are then sent through the dial-in access port 12 and reproduced on Cobalt's remote system.

Once received by the remote system 16, the data of interest is extracted from the downloaded reports. The usual approach is to display the reports on the remote system's display screen and extract the data of interest using known “screen scrape” techniques or software. Snaglt, distributed by TechSmith, is one of many software applications that may be used to capture data displayed on a computer screen. Other such software applications include wIntegrate, ProComm, Reflections and the like. As illustrated by block 36, the extracted data is transformed into a “capture file”. The capture file is usually a conventional flat data file.

At block 40, the capture file is imported into a vendor's system. This process may involve additional data manipulation or formatting specific to the particular vendor's application or service. At some point, however, the data extracted from the dealer's DMS 4 becomes available for use by the vendor in providing value added services to the dealership and/or its customers.

Unfortunately, the above-described process for remotely accessing data from a dealer's DMS 4 suffers from a number of shortcomings. Generally, communications to the DMS 4 received from the dial-in access port 12 are given a lower priority than communications received from client devices (e.g., terminals 8.) That is, most dealership systems are programmed to consider client initiated transactions more important than remote transactions. During dealership business hours, for example, the DMS 4 may be busy with dealer initiated transactions from client devices (e.g., transactions from salespersons and other dealership employees). These client transactions are queued and processed before remote transactions communicated to the DMS 4 through the dial-in access port 12. Generally, the DMS 4 processes remote transactions only when the system is idle with no pending client activity. As such, remote requests communicated to the DMS 4 through the dial-in access port 12 typically experience significant processing delays, if they are even successful at connecting at all.

To minimize processing delays, vendors typically initiate remote transactions with the DMS 4 when the dealership is closed for business. During these times, the DMS 4 is most likely to be free from processing client initiated transactions. In the current dealership environment, there are a large number of vendors attempting to collect dealer data during off-hours. Ordinarily, these vendors collect data from each dealership they service. Dealership systems are normally bombarded during the night with vendors attempting to connect to the DMS 4. As such, attempts to dial in to the DMS 4 are often met with a busy signal.

Because the competition for dial-in connection is so ferocious, most vendors only dial in and download dealer data once every twenty-four hours. During the twenty-four hour period, however, dealer data stored in the DMS 4 may change and vendors may be relying on stale data when providing their services. In other words, downloaded data becomes out of date as soon as it is collected and the remote dialup session ends. One way to insure current data, therefore, is with a more continuous connection to the DMS 4, which is not possible with the current state of the art.

In addition to processing delays, there is an expense for phone calls made by the vendor's remote system 16 to the DMS 4. As described above, most vendors service hundreds if not thousands of dealerships. These dealerships are located in different states throughout the country. For a large majority of the dealerships, long distance service is required for the remote dialup connection to the DMS 4. As with any other long distance call, the vendor is charged a fee by a telecommunication carrier for the long distance connection. Because of processing delays, the long distance charges are exacerbated when a vendor connects to a dealer's DMS 4 during regular business hours. This is because low priority remote transactions must compete with higher priority client activity.

A security risk also exists with the current methods used by vendors to extract dealer data from the DMS 4. For most dealership systems, a simple disclosure of the logon and password information can result in unauthorized access to the dealer's data. Essentially, anyone with a modem and dealership pass-code information can gain access to a dealer's DMS 4.

The DMS provider could also raise a legal objection because data acquisition via dialup is not typically addressed in the dealer agreement with the provider. This is also not a guaranteed service of the product to the dealer. The DMS provider could make changes, for example, to the system or the dial-in access port 12 that could potentially take the remote data collection process offline.

A number of different potential failure points exist in the above-described process for accessing dealer data through the dial-in access port 12. The current methods are dependent on the “last mile” connection to the dealer's DMS 4. For example, the remote connection 20 to the DMS 4 must traverse the local loop of the local telephone company's telecommunication network, which could be in use at the time of an attempted connection, be offline for any number of reasons, or interrupted by the DMS provider. The vendor must also rely on screen scrape techniques to extract data from generated reports, which requires specific knowledge of report formats. Moreover, the captured data usually requires additional processing for importing to the vendor's system. The aforementioned possible points of failure make the process more attended rather than automatic and therefore involve a labor cost.

It would be desirable to provide a remote data access system and method suitable for use with dealer management systems that function essentially in real-time, without using a maintenance port for access. It would be desirable for such a system to be secure, flexible, and capable of operating without failure in the event of an underlying redesign of the DMS. It would be further desirable for such a remote access system to be substantially transparent to currently available DMS operations, and be usable without making any substantial modifications to the DMS.

The present invention is directed to overcoming, or at least reducing the effects of, one or more of the problems set forth above.

### SUMMARY OF THE INVENTION

In one aspect of the invention, a method for remotely collecting data from a dealer management system is provided. The method includes identifying a dealer management system that is coupled to a secure data access port. The secure data access port is also coupled to a public network, and the dealer management system is coupled to at least one client device and is operable to process dealer initiated transactions from the client device. A remote system remotely connects to the dealer management system using the public network. The remote connection is a public connection established through the secure data access port, and the secure data access port is operable to pass remote transactions received from the remote system to the dealer management system. A remote transaction is forwarded from the remote system to the dealer management system. The remote transaction includes a request for stored data and is given a priority level by the dealer management system that is similar to client initiated transactions. The requested data is received at the remote system from the dealer management system.

In another aspect of the present invention, a system to facilitate the remote collection of data is provided. The system includes a secure data access port coupled to a public network and a dealer management system. The dealer management system is coupled to at least one client device and is operable to process dealer initiated transactions from the client device. The secure data access port is cooperatively operable with the dealer management system to accept a remote connection from a remote system. The remote connection is established with the secure data access port, and the secure data access port is operable to pass remote transactions received from the remote system to the dealer management system. The secure data access port is operative to receive a remote transaction from the remote system and forward the remote transaction to the dealer management system. The remote transaction includes a request for stored data and is given a priority level by the dealer management system that is similar to client initiated transactions. The secure data access port is operable to forward the requested data received from the dealer management system to the remote system.

### BRIEF DESCRIPTION OF THE DRAWINGS

The invention may be best understood by reference to the following description taken in conjunction with the accompanying drawings, in which like reference numerals identify like elements, and in which:

FIG. 1 illustrates a conventional dealer management system;

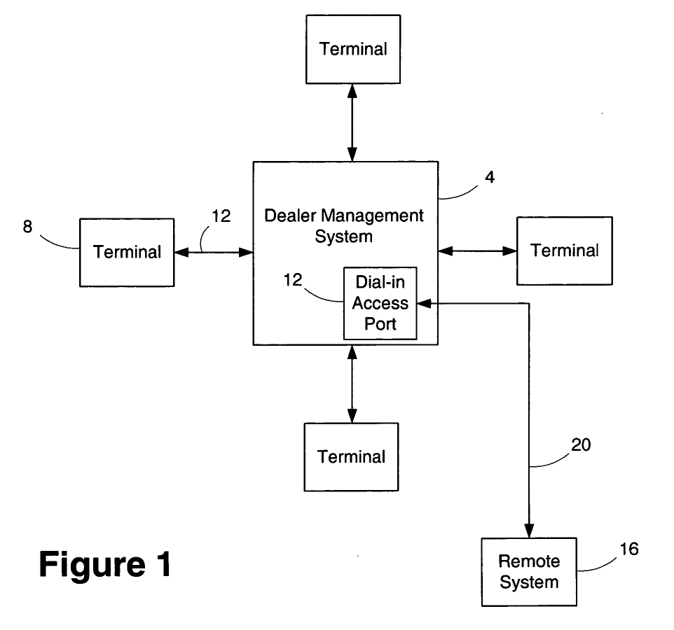

FIG. 2 is a simplified block diagram illustrating a conventional method used to collect data from the dealer management system illustrated in FIG. 1;

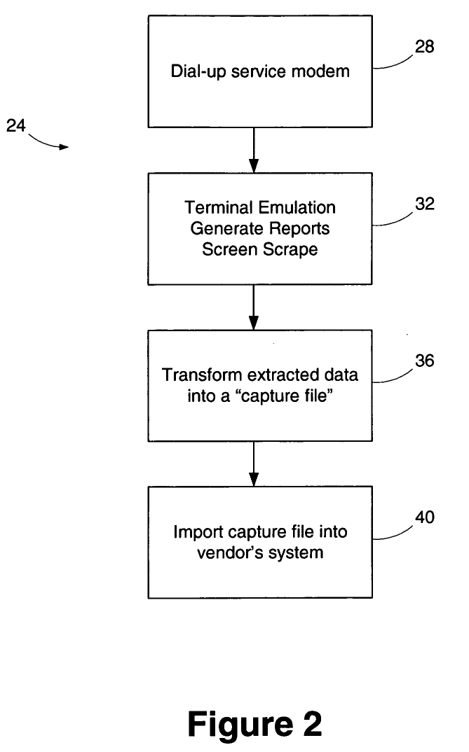

FIG. 3 illustrates a dealer management system coupled to a secure data access port that is operable to communicate with a public network;

FIG. 4 illustrates a functional block diagram of one exemplary embodiment of the secure data access port illustrated in FIG. 3;

FIG. 5 illustrates another exemplary embodiment of the secure data access port illustrated in FIG. 3;

FIG. 6 is a simplified block diagram illustrating one exemplary process for collecting data from a dealer management system;

FIG. 7 illustrates a data aggregation system that is operable for collecting data from a dealer management system;

FIG. 8 is a simplified block diagram illustrating one exemplary process for collecting data from a dealer management system; and

FIG. 9 illustrates one exemplary application of a data aggregation system.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

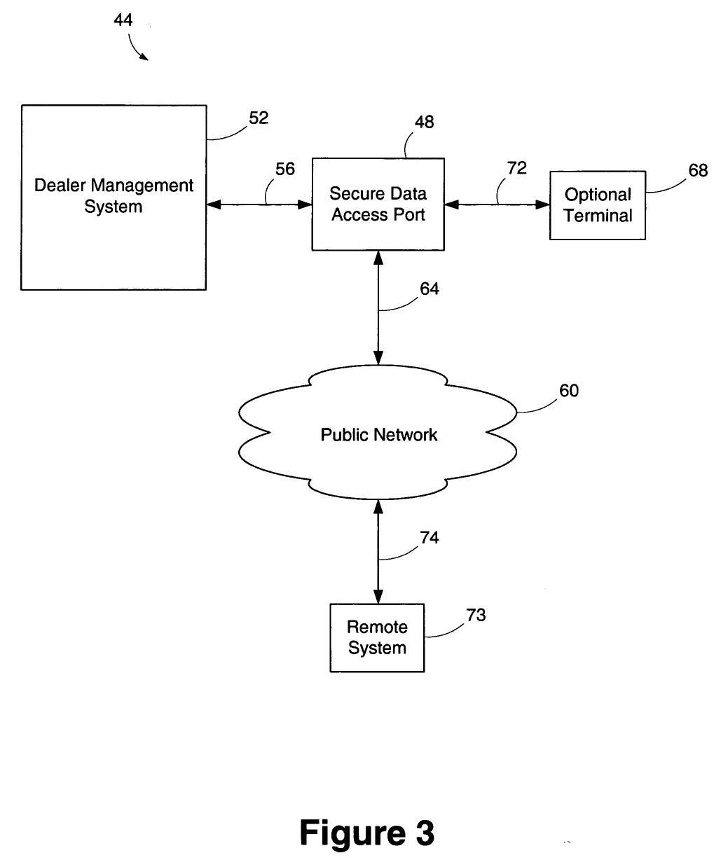

Referring to FIG. 3, a data acquisition system 44 in accordance with one embodiment of the present invention is shown. The data acquisition system 44 includes a secure data access port 48 coupled to a traditionally isolated data management system, such as an automobile dealer's dealer management system 52. Although the implementation of the present invention will be described with reference to the illustrated and previously described DMS 52, it should be appreciated, however, that the invention is also equally applicable to any number of other data management systems that have traditionally been isolated from publicly available networks, such as the Internet.

The secure data access port 48 is coupled to the DMS 52 through a communication link 56. As with terminals connected to the DMS 52, the communication link 56 may include any number of hardware and protocol configurations. For example, the secure data access port 48 may be coupled to the DMS 52 using a serial cable, Ethernet connection, wireless connection, and the like. Typically, the communication link 56 includes a dedicated or network connection to the DMS 52 that allows the secure data access port 48 to have full-time continuous connectivity with the DMS 52.

In one embodiment, the secure data access port 48 is connected to the DMS 52 in the same manner as any other client device. With this configuration, the DMS 52 may be unable to differentiate between transactions received from the secure data access port 48 and other client devices. As a result, transactions sent to the DMS 52 from the secure data access port 48 are given essentially the same priority level as client initiated transactions.

The secure data access port 48 is also coupled to a public network 60, which in this illustrative example is the Internet. With the present invention, the secure data access port 48 is capable of being coupled to the public network 60 with minimal hardware and protocol configuration. Conventional approaches to secure remote connectivity, such as virtual private networking, use “tunneling” and other techniques to convert a public connection into a private connection. These conventional approaches add an additional layer of complexity and cost to most systems.

Ordinarily, the data access port 48 is coupled to the Internet using a public communication link 64. The public communication link 64 may include any number of hardware and protocol configurations. The public communication link 64 may be, for example, hard wired or wireless and typically uses the TCP/IP protocol. In a wireless embodiment, the public communication link 64, as well as any other communication links in the system 44, may be configured using the 802.11 standard, generally referred to as Wi-Fi.

In a typical configuration, the secure data access port 48 is located, in a logical sense, outside the dealer's firewall. Using a router, the secure data access port 48 may share the dealer's existing Internet connection. Alternatively, the public communication link 64 may include a separate dedicated Internet connection. Moreover, the public communication link 64, as well as any other communication links described herein, may include any number of intermediate devices, such as routers, repeaters, gateways, and the like. In short, the particular configuration of the public communication link 64, as well as other system details, is likely to vary depending upon the particular implementation of the present invention.

The DMS 52 is usually configured to allow only a certain number of connected client devices. With the present invention, the secure data access port 48 is preferably coupled to the DMS 52 using one of these connections. To minimize the intrusion into a dealer's existing system, the secure data access port 48 may provide pass-through DMS connectivity for an optional terminal 68.

The optional terminal 68 is coupled to the secure data access port 48 through a communication link 72. In this example, when the secure data access port 48 is not in use, the optional terminal 68 is able to communicate with the DMS 52 as any other dedicated terminal ordinarily would. In other words, the pass-through connection is transparent in operation, and the terminal session appears the same to the user. This configuration prevents the secure data access port 48 from tying up a DMS data port. In short, the optional terminal 68 and the secure data access port 48 can share a single DMS data port.

During setup, the secure data access port 48 is assigned an Internet Protocol (IP) address. The IP address may be configured dynamically or set to a static IP address. Once connected to the public network 60 and configured with an IP address, the secure data access port 48 is intentionally made available to the Internet. For example, a remote system 73 with a connection 74 to the Internet 60 may communicate with the secure data access port 48 using conventional TCP/IP protocol. However, as will be described below, security measures may be implemented so that use of the secure data access port 48 is limited to only authorized users.

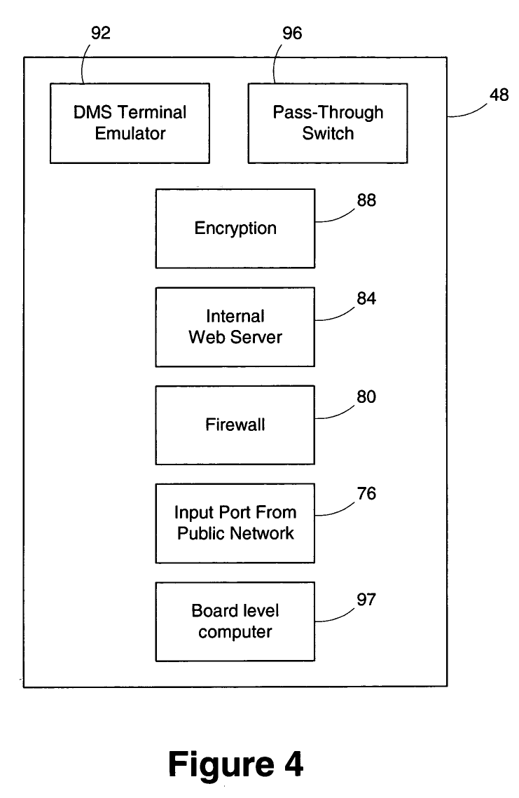

Referring to FIG. 4, a block diagram of the secure data access port 48 is shown. In this example, the secure data access port 48 includes an input port 76, a firewall 80, an internal web server 84, an encryption module 88, a DMS terminal emulator 92, and a pass-through switch 96. It should be appreciated, however, that this is but one of many possible embodiments. Other examples may not include all of the features described in the illustrative embodiment, but still be within the scope of the present invention.

The input port 76 provides the interface to the public network 60. The firewall 80 provides access to the internal web server 84 used for configuration, communications, and reprogramming purposes. The firewall 80 provides an additional layer of pass-code protection to the DMS 52. To gain access to the secure data access port 48, the remote system 73 provides a pass-code, such as a user ID and password. If not accepted, the remote system 73 is denied access to the secure data access port 48.

The internal web server 84 and the encryption module 88 are operable to encrypt and decipher encrypted communications between the secure data access port 48 and the remote system 73 using any number of different encryption techniques. In one embodiment, the secure data access port 48 communicates with the remote system 73 using the Secure Shell (‘SSH’) protocol.

As an additional layer of security, communications sent and received by the secure data access port 48 may be protected using a public and private key pair. One approach is to apply a public key to the internal firmware of the secure data access port 48 and to turn off all non-SSH protocols. When implemented in such a manner, a remote system 73 attempting a remote connection to the DMS 52 through the secure data access port 48 provides the private key that matches the public key held by the secure data access port 48. Requests that cannot be verified are rejected, whereas legitimate requests create a secure SSH session that allows the requester to provide a pass-code. After providing a pass-code to the secure data access port 48, the remote system 73 logs on to the DMS 52 as if it were a client connected user. As such, the remote system 73 may be required to provide two pass-codes to establish a remote session with the DMS 52 through the secure data access port 48.

The DMS terminal emulator 92 emulates a standard terminal or other device that is ordinarily connected to the DMS 52. Remote transactions received by the secure data access port 48 may be forwarded to the DMS 52 in the same format used by client connected devices. For example, the remote transaction may be transformed into a serial data stream acceptable for transmission to the DMS 52. Likewise, data collected from the DMS 52 may be formatted for IP delivery before it is forwarded to the remote system 73. For example, the collected data may be formatted for transmission over the Internet using the TCP/IP protocol. The pass-through switch 96 allows the optional terminal 68 to be connected to the secure data access port 48 for standard access if desired.

In another embodiment, the secure data access port 48 may include a board level computer 97. It should be appreciated that the board level computer 97 may be configured to perform the previously described functionality of the secure data access port 48. In other words, rather than including a plurality of different modules, the functionality of the secure data access port 48 may be bundled into the board level computer 97 or similar device.

The board level computer 97 generally serves to increase the functionality and configurability of the secure data access port 48. For example, if the secured data access port 48 is connected to a dealer network and a public network, the board level computer 97 may allow a remote user to “see” both networks and make configuration changes on the fly. The dealer network, for example, may be configured initially for serial connectivity. If, at a later time, the dealer switches to a TCP/IP type network, a remote user may be able to “see” this change and remotely configure the secure data access port 48 to operate with such a configuration.

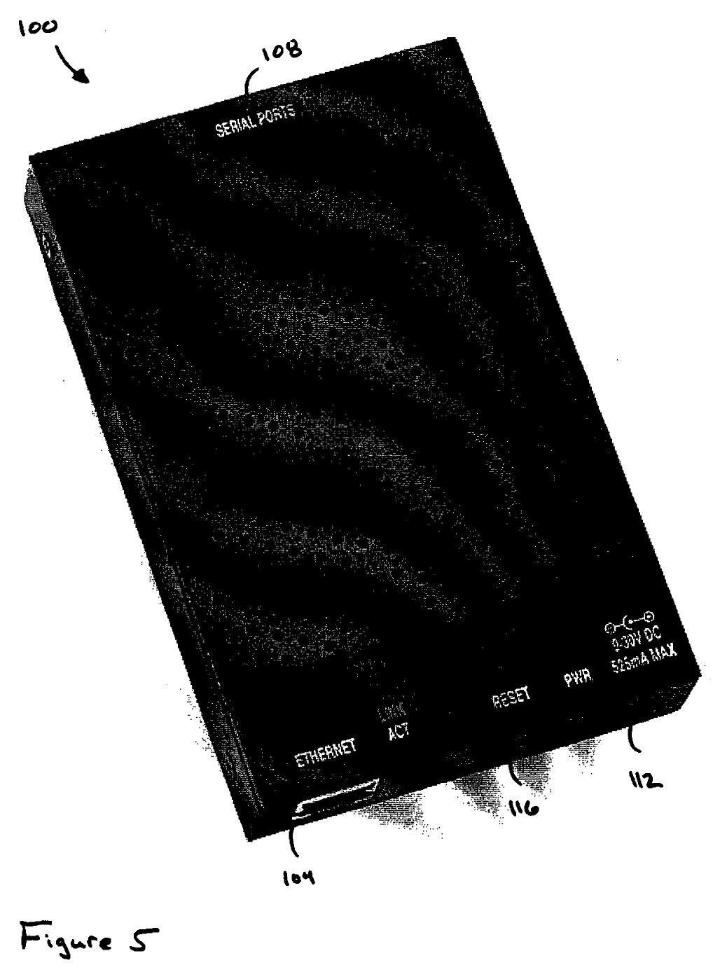

Referring to FIG. 5, an illustrative secure data access port 100 in accordance with one embodiment of the present invention is shown. The secure data access port 100 includes an Ethernet port 104 for connecting to the Internet. Serial ports 108 are shown for connecting the secure data access port 100 to the DMS 52 and for connecting the optional terminal 68 to the pass-through switch 96. The secure data access port 100 also includes a power connection 112 and a reset switch 116.

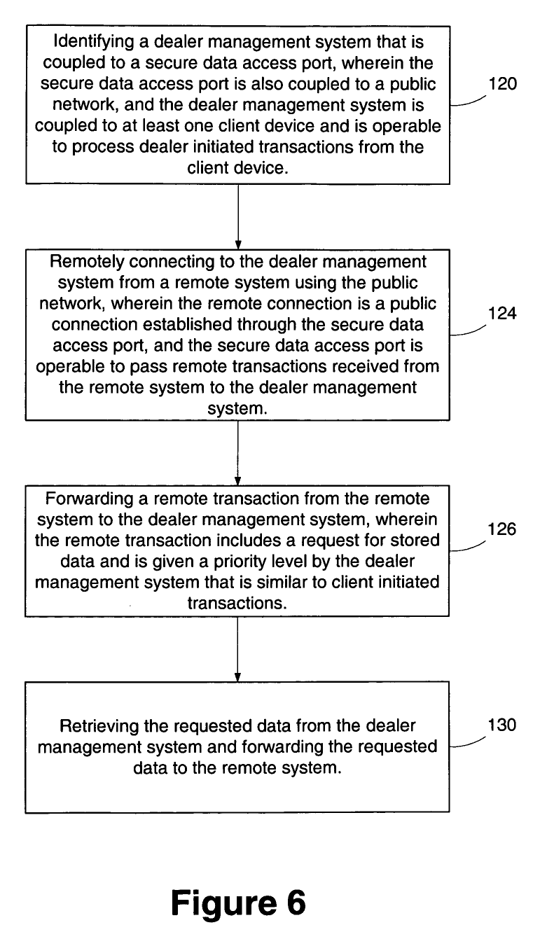

Referring to FIG. 6, a method for remotely accessing a dealer's DMS is shown. This process is discussed with reference to the secure data access port 48, illustrated in FIGS. 3 and 4, to simplify the discussion of the present invention. It should be appreciated, however, that alternative embodiments of the secure data access port 48 and other system components may be used with the described method.

At block 120, a dealer management system 52 is identified that is coupled to a secure data access port 48. The secure data access port 48 is also coupled to a public network 60. The dealer management system 52 is coupled to at least one client device 8 and is operable to process dealer initiated transactions (e.g., requests for stored data) from the client device 8. In the typical case, the public network 60 is the Internet, and the client devices 8 connected to the DMS 52 are dedicated terminals 68, whose primary function is to allow dealership personnel to initiate communication sessions with the DMS 52.

At block 124, a remote system 73 connects to the dealer management system 52 using the public network 60. The remote connection is a public connection established through the secure data access port 48, and the secure data access port 48 is operable to pass remote transactions received from the remote system 73 to the dealer management system 52. Generally, the remote system 73 is a computer, server, or other electronic device.

As described above, the secure data access port 48 is connected to both the DMS 52 and the public network 60. Those skilled in the art will appreciate that the secure data access port 48 may be directly coupled to the DMS 52 or connected to the DMS 52 through intermediary devices or networks. The remote system 73 initiates the remote connection, for example, by entering the IP address of the secure data access port 48. It should also be appreciated that the IP address entered may be expressed numerically or textually through a domain name and that entering either for connecting to the secure data access port 48 is within the scope of the invention.

To ensure a secure connection, the remote system 73 may be required to provide a private key that matches a public key of the secure data access port 48. If a match exists, the secure data access port 48 will accept communication from the remote system 73. Otherwise, communication from the remote system 73 is denied. It should be appreciated, however, that any number of encryption techniques may be used with the present invention. As another example, when initiating the remote connection, the remote system 73 may provide the secure data access port 48 with its IP address. The secure data access port 48 may determine whether the IP address provided is an accepted IP address. For example, the secure data access port 48 may compare the IP address of the remote system 73 with at least one other IP address (e.g., a trusted IP address list) and only accept the remote connection if there is a match. These techniques may be implemented, for example, in a manner that is transparent to the user.

As an additional or separate layer of security, the remote system 73 may be prompted to provide a pass-code to the secure data access port 48. If the pass-code is not approved, the remote system 73 is turned away. Otherwise, the remote system 73 is considered an authorized user, which allows the remote system 73 to communicate with the DMS 52 through the secure data access port 48.

Once the remote connection to the DMS 52 is established, the remote system 73 logs on to the DMS 52 by providing a pass-code. This second pass-code may include security attributes that determine what dealer data the remote system 73 will be permitted to access. In this illustrative embodiment, the remote system 73 must provide two separate pass-codes to download data from the DMS 52, one for the secure data access port 48 and one for the DMS 52. In an alternative embodiment, the secure data access port 48 may not require a pass-code, or the secure data access port 48 may use the same pass-code as the DMS 52, thus requiring the remote system 73 to provide only one pass-code to establish the remote session with the DMS 52.

With the present invention, remote sessions with the DMS 52 may be secured using encryption, pass-codes, and/or other techniques. Because the secure data access port 48 is connected to the DMS 52 in a manner similar to client devices 8, it is more resilient to DMS system changes or updates. In other words, unlike the DMS service modem, it is less likely that changes to the DMS 52 would affect the operability of the present invention. The present invention also provides essentially continuous connectivity with the DMS 52, which allows for the possibility of up to the minute data resolution for remotely connected vendors.

At block 126, a remote transaction is forwarded to the DMS 52 from the remote system 73. The remote transaction includes a request for stored data and is given a priority level by the DMS 52 that is similar to client initiated transactions. Generally, the remote transaction sent from the remote system 73 may include DMS commands, scripts, routines, instructions, text, or any other type of data destined at least in part for the DMS 52. The remote transaction is received by the secure data access port 48 and forwarded to the DMS 52 in an accepted format. In one embodiment, for example, the DMS terminal emulator 92 of the secure data access port 48 transforms the remote request into a format that is used by client terminals.

Because the DMS 52 treats transactions received from the secure data access port 48 similar to dealer initiated transactions, remote transactions no longer compete with client transactions for processing by the DMS 52. Instead, the DMS 52 is typically unable to distinguish between remote transactions and client transactions and views them in a similar manner. As such, remote session with the DMS 52 may be initiated during regular dealership business hours or at any other time, without experiencing the processing delays seen with previously used methods. Moreover, because a remote transaction is forwarded to the DMS 52 over the public network 60, no long distance fees are generated.

The remote system 73 is also no longer required to collect dealer data using screen scrape techniques from generated reports. With the present invention, data may be directly collected from the DMS 52 and sent to the remote system 73. In one embodiment, the remote system 73 may be configured to have direct file level access to data stored in the DMS 52. For example, the remote system 73 may have command level interaction with the Pick database used by the DMS 52. A number of different software packages may be used with the remote system 73 to facilitate this type of operability with the DMS 52. One example is wIntegrate, distributed by IBM.

At block 130, the requested data is retrieved from the DMS 52 and forwarded to the remote system 73. As explained, the DMS 52 prioritizes transactions received from the secure data access port 48 similar to client initiated transactions. As such, remote requests for data are not pushed to the end of the line, but are processed in turn. Once processed, the requested data is forwarded to the secure data access port 48 and then on to the requesting remote system 73.

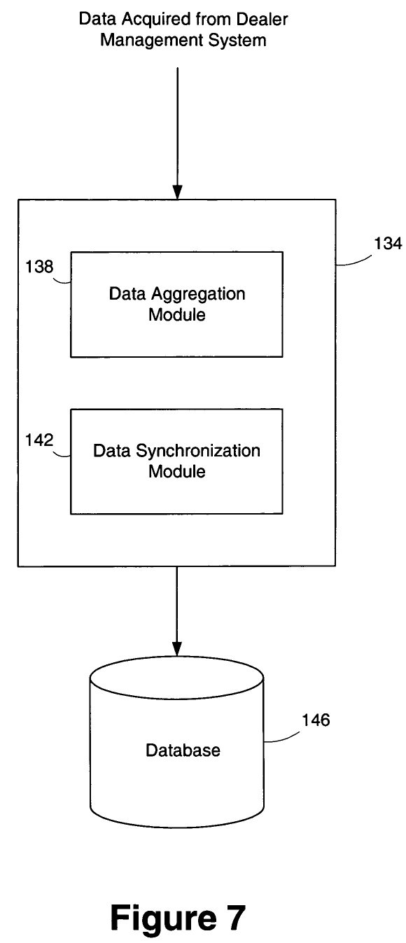

Referring to FIG. 7, a data aggregation system 134 in accordance with another embodiment of the present invention is shown. The data aggregation system 134 includes a data aggregation module 138 and a data synchronization module 142, and the system 134 is coupled to a secure data access port 48, as described above. The data aggregation system 134 is operable to repeatedly download data from dealer management systems on a regularly scheduled basis. The download schedule is variable so that the resolution rate of the downloaded data may be set as desired. For example, the data aggregation system 134 may be set to download dealer data every five minutes, every two minutes, or at any other desired interval.

A copy of the downloaded data is stored in a database 146 that is coupled to the data aggregation system 134. In this illustrative example, the data aggregation module 138 is responsible for communicating with the DMS 52 through the secure data access port 48 and downloading data of interest. The data synchronization module 142 communicates with the database 146 using, for example, SQL statements and is responsible for populating the database 146 with the collected data. When data is downloaded from the DMS 52, the database 146 may be updated with any changes in dealer data that occurred from the time of the last download. As such, the data aggregation system 134 may be used by vendors to ensure that the services they provide are based on current dealer data.

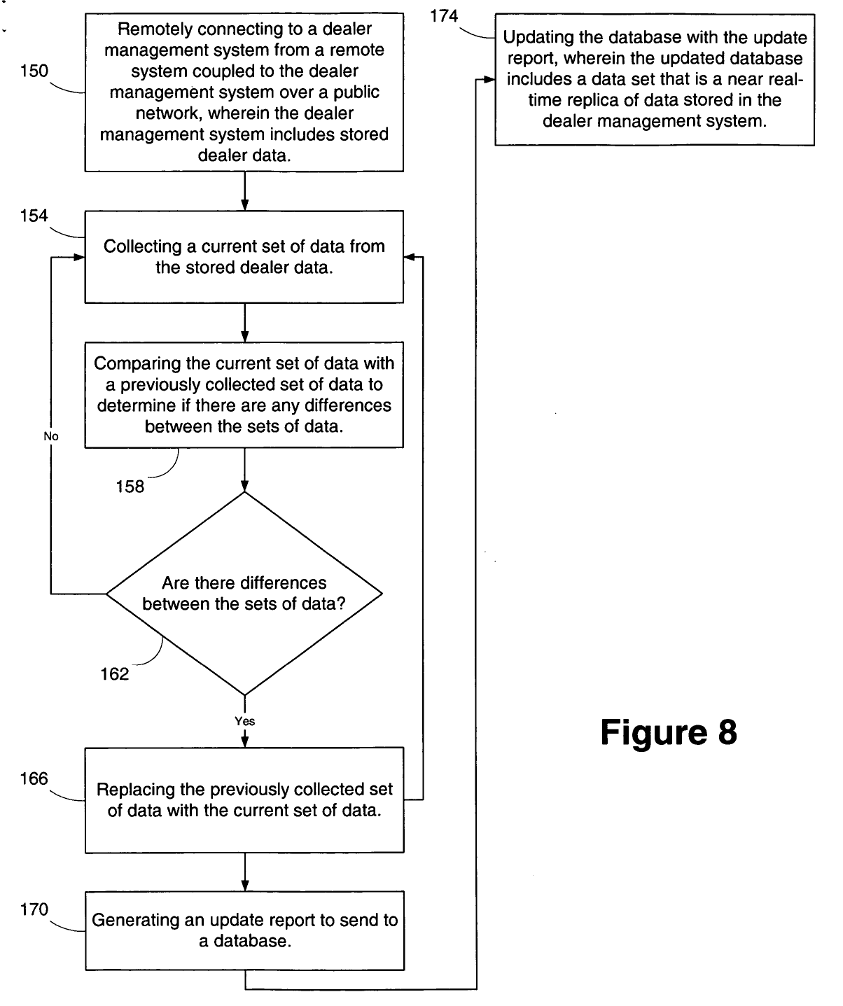

Referring to FIG. 8, a method for collecting data from dealer management systems is shown. This process is discussed with reference to the data aggregation system 134, illustrated in FIG. 7, and the secure data access port 48, illustrated in FIGS. 3 and 4, to simplify the discussion of the present invention. It should be appreciated, however, that alternative embodiments of the data aggregation system 134 and the secure data access port 48 may be used with the described method.

At block 150, the data aggregation system 134 remotely connects to a dealer management system 52 over a public network 60. As described above, the remote connection may be established over the Internet using the IP address of the secure data access port 48. Depending upon the anticipated volume of remote activity, the secure data access port 48 may be designed to simultaneously handle numerous remote sessions. In other words, the secure data access port 48 may be configured to simultaneously process remote sessions from multiple data aggregation systems 134 and other remote systems 73.

The data aggregation system 134 remotely communicates with the DMS 52 through the secure data access port 48. In an alternative embodiment, however, the data aggregation system 134 may be connected to the DMS 52 in a manner that is similar to client devices. To gain access to dealer data, the data aggregation system 134 provides a pass-code to the DMS 52. In the usual case, the pass-code determines what dealer data the remote system 134 is permitted to access. For example, a dealership may provide Cobalt with a pass-code that permits access to customer and marketing data stored in the DMS 52.

After entering the pass-code, the data aggregation system 134 communicates requests for data to the DMS 52. The requests for data may be forwarded to the DMS 52, for example, by the DMS terminal emulator 92. As the DMS 52 processes requests, the results are reported back to the data aggregation system 134 and received, in this example, by the data aggregation module 138. At block 154, a current set of data is collected from the stored dealer data.

At block 158, the current set of data is compared with a previously collected set of data to determine if there are any differences between the sets of data. In normal operation, the data aggregation system 134 is set to repeatedly and automatically collect data at an adjustable interval of time. For example, the data aggregation system 134 may be set to collect data at thirty-second intervals or any other desired schedule. When a current set of data is collected, it is compared with a previously collected set of collected data, reserved by the data aggregation system 134 for this purpose. The previously collected data set represents the state of the database (for the data set being considered) prior to the present moment. The current data set is the data set received by the data aggregations system's 134 current request for data from the DMS 52. If the dealer's data has changed, the comparison will reveal the changes.

In another embodiment, the comparison between the current set of data and the previously collected set of data may be performed by the secure data access port 48, rather than the data aggregation system 134. For example, if so equipped, the comparison may be performed by the board level computer 97 or other intelligence of the secure data access port 48. Likewise, the secure data access port 48 may function to reserve the previously collected set of data for the comparison. One approach is for the secure data access port 48 to only push identified changes in dealer data to the data aggregation system 134, which serves to reduce network traffic and unnecessary processing by the data aggregation system 134. In this embodiment, the secure data access port 48 essentially functions as the data aggregation module 138 of the data aggregation system 134.

If there are no differences between the previous and current sets of data, the current set of data is discarded. Alternatively, the process may be configured to have the previously collected set of data automatically overwritten with the current set of data regardless of whether there are any differences. From decision block 162, the process returns to block 154, and the data aggregation system 134 continues to collect current sets of data at the set interval. If the comparison reveals that the dealer data has changed, at block 166, the previously collected set of data is replaced by the current set of data and reserved by the data aggregation system 134 for future comparisons.

Although this process has been described for one current set of data and a corresponding previously collected set of data, the process may be repeated for any number of sets of data. Ordinarily, the data aggregation system 134 cycles through a series of requests for data until all data sets of interest have been collected from the DMS 52. In other words, the data aggregation system 134 is operable to collect multiple sets of data. For example, a first data set of interest may include customer data. A second data set may include inventory data and warranty data. A third data set may include sales data. When directed to do so, the data aggregation system 134, cycles through and collects current first, second, and third sets of data and compares these sets of data, against previously collected first, second, and third sets of data.

Because pass-codes may restrict access to only certain dealer data, during a data collection cycle, the data aggregation system 134 may have to log on and off the DMS 52 several times, providing a new pass-code for a particular data set of interest. Even so, the data sets should be collectable in a time period of a few seconds to a few minutes, depending upon the amount of data involved and the data rates of the various connections involved. Once a cycle has been completed, a new cycle may be started. In this manner, the data aggregation system 134 may repeatedly scan the DMS 52, requesting current data, so that any changes in dealer data are quickly noticed.

From block 166, the process returns to block 154 and also moves in parallel to block 170. At block 154, as previously described, the data aggregation system 134 continues with collecting data from the DMS 52. At block 170, an update report is generated to send to the database 146. In the previously described example, the data synchronization module 142 is responsible for generating and forwarding the update report to the database 146. The update report may include a flat data file, SQL statements, Microsoft Access file, or any other data indicating the changes in dealer data. At block 174, the database 146 is updated with the noted changes in dealer data. Once updated, the database 146 includes a data set that is a near real-time replica of data stored in the DMS 52.

As described, the data aggregation system 134 is operable to download and update data sets of interest from the DMS 52. The data sets collected may be selectively determined from data stored in the DMS 52. The collected data may then be used for reports, for providing vendor services to the dealership, or for any other purpose. For example, Cobalt may use the collected data stored in the database 146 to generate customer reports for a dealership. A parts supplier may build an inventory replenishment program that looks to the data aggregation system 134 to determine when a dealership's parts inventory is low. Essentially, once near real-time data is available at the data aggregation system 134, it can be used in nearly any manner desired.

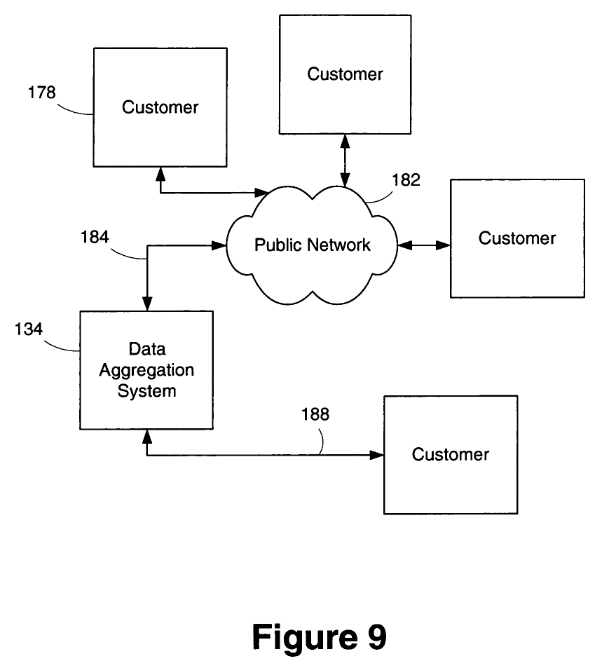

In FIG. 9, one application of the data aggregation system 134 and the collected data is shown. In this example, customers 178, such as vendors or other providers, interested in dealer data may contract for access to certain data through the data aggregation system 134. This has the advantage of saving the customer 178 the costs (e.g., hardware costs, operating costs, technical expertise, etc.) associated with collecting dealer data themselves. This also has the advantage of minimizing remote requests for data from a dealer's DMS. Essentially, the operator of the data aggregation system 134 becomes a service provider or reseller of dealer data.

The customers 178 may access the data aggregation system 134 using a variety of different methods. The most convenient method is through a public network 182, such as the Internet. The data aggregation system 134 and customers 178 are coupled to the public network 182 using communication links 184. In this example, the data aggregation system 134 is assigned an IP address, and the customers 178 may communicate with the data aggregation system 134 using the TCP/IP protocol. Customers 178 may also configure their communication with the data aggregation system 134 using private communication links 188.

With this application of the data aggregation system 134, a customer 178 typically contracts with a dealership for access to the dealer's DMS 52. If an agreement is reached, the dealership provides the customer 178 with a document or letter that shows the customer 178 is authorized to access the DMS 52. A pass-code may also be given to the customer 178, which ordinarily provides restricted access to certain data stored in the DMS 52.

At this point, rather than collecting dealer data themselves, the customer 178 arranges to have the data collected by the data aggregation system 134. Generally, the operator of the data aggregation system 134 and the customer 178 negotiate a services agreement that includes terms directed to the collection and availability of dealer data. Alternatively, instead of negotiating the services agreement with the actual operator of the system 134, the customer 178 may deal with a middle person that has arranged for the collection of dealer data from a third party, such as the operator of a data-warehouse or server-farm.

The typical services agreement includes terms for the collection of dealer data. For example, the parties typically agree on a collection interval for the dealer data. In other words, the services agreement includes representations as to how current the customer's data will be. Ordinarily, the customer 178 is interested in having access to dealer data that is a near real-time replica of data stored in the DMS 52. To this end, the services agreement may represent that the collection interval shall be set to one minute or less, thus representing that the collected data made available by the data aggregation system 134 will not be more than one minute old. The parties may agree, however, to any collection interval. As a check, when data is collected by the data aggregation system 134, it may be associated with a time-stamp or other indicator, so that the customer 178 is able to verify that the terms of the services agreement are being satisfied and that the customer 178 is accessing current data.

The services agreement may also include terms directed to the availability of the collected dealer data. For example, the services agreement may include representations as to when the collected data is to be made available to the customer 178. Typically, the customer 178 will want the ability to access the collected data from the data aggregation system 134 at any time (i.e., continual availability). In this regard, the services agreement may guarantee a certain up time for the data aggregation system 134. For example, the services agreement may guarantee that during a given time period (e.g., twenty-four hours, week, month, etc.) the data aggregation system 134 will be accessible 99% of the time. This may be subject, however, to scheduled maintenance periods. The services agreement may represent that that the customer 178 is responsible for resolving any interruptions that occur due to issues with the public network 182 or communication links 184 and 188.

The services agreement includes terms directed to payment for the services provided. The customer 178 may negotiate any number of payment options. For example, the services agreement may be based on periodic payments, a flat fee, or both. Essentially, the parties are free to negotiate the terms as they see fit.

To begin collecting data, the data aggregation system 134 is provided the customer's pass-code. As described above, pass-codes generally provide restricted access to certain data in a dealer's DMS 52. The data aggregation system 134 may be configured to collect some or all the dealer data the pass-code provides access to. The data aggregation system 134 collects the data at the agreed upon collection interval. After collection begins, the customer 178 may access the data aggregation system 134 and retrieve current dealer data. Alternatively, the data management system 134 may automatically forward collected data to the customer 178. Access to the collected data may be protected using pass-codes, encryption, or any other known security measures.

As indicated above, aspects of this invention pertain to specific “method functions” implementable through various computer systems. In an alternate embodiment, the invention may be implemented as a computer program product for use with a computer system. Those skilled in the art should readily appreciate that programs defining the functions of the present invention can be delivered to a computer in many forms, which include, but are not limited to: (a) information permanently stored on non-writeable storage media (e.g., read only memory devices within a computer such as ROMs or CD-ROM disks readable only by a computer I/O attachment); (b) information alterably stored on writeable storage media (e.g., floppy disks and hard drives); or (c) information conveyed to a computer through communication media, such as a local area network, a telephone network, or a public network like the Internet. It should be understood, therefore, that such media, when carrying computer readable instructions that direct the method functions of the present invention, represent alternate embodiments of the present invention.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method for remotely collecting data from a dealer management system, comprising:
identifying a dealer management system that is coupled to a secure data access port, wherein the secure data access port is also coupled to a public network, and the dealer management system is coupled to at least one client device and is operable to process dealer initiated transactions from the client device;
remotely connecting to the dealer management system from a remote system using the public network, wherein the remote connection is a public connection established through the secure data access port, and the secure data access port is operable to pass remote transactions received from the remote system to the dealer management system;
forwarding a remote transaction from the remote system to the dealer management system, wherein the remote transaction includes a request for stored data and is given a priority level by the dealer management system that is similar to client initiated transactions; and
receiving at the remote system the requested data from the dealer management system.

2. The method of claim 1, wherein remotely connecting to the dealer management system from a remote system using the public network comprises remotely connecting to the dealer management system using the Internet.

3. The method of claim 2, wherein the secure data access port is assigned an IP address, and the remote system connects to the dealer management system using the Internet by entering the IP address of the secure data access port.

4. The method of claim 1, wherein the secure data access port includes a security module that is operable to execute a security protocol that restricts access to the secure data access port, wherein the security protocol includes:
when initiating the remote connection with the secure data access port, providing a private key that corresponds to a public key previously associated with the secure data access port;
if the private key corresponds with the public key, the remote system is granted access to the secure data access port, otherwise remote access is denied.

5. The method of claim 1, wherein the secure data access port includes a security module that is operable to execute a security protocol that restricts access to the secure data access port, wherein the security protocol includes:
when initiating the remote connection with the secure data access port, providing an IP address of the remote system to the secure data access port, wherein the secure data access port is operable to determine if the IP address is an accepted IP address, and if the IP address is determined to be an accepted IP address, the remote system is granted access to the secure data access port, otherwise remote access is denied.

6. The method of claim 1, wherein the secure data access port includes a security module that is operable to execute a security protocol that restricts access to the secure data access port, wherein the security protocol includes:
when initiating the remote connection with secure data access port, providing a pass-code to the secure data access port; and
if the pass-code is determined to be a valid pass-code, the remote system is granted access to the secure data access port, otherwise remote access is denied.

7. The method of claim 1, further comprising:
logging on to the dealer management system by providing a pass-code, wherein the pass-code provides file level access to certain data stored in the dealer management system, and the remote transaction includes a command to directly access data from the dealer management system.

8. The method of claim 1, further comprising:
in the secure data access port, transforming the remote transaction into a format that is acceptable for processing by the dealer management system, wherein the transformed transaction is in substantially the same format as client initiated transactions; and
in the secure data access port, transforming the requested data received from the dealer management system into a format acceptable for transmission over the public network.

9. The method of claim 8, wherein the requested data received from the dealer management system is transformed into data packets acceptable for transmission to the remote system using the TCP/IP protocol in an encrypted format.

10. The method of claim 8, wherein the remote transaction received from the remote system is transformed into a serial data stream acceptable for transmission to the dealer management system.

11. The method of claim 1, wherein remotely connecting to the dealer management system from a remote system using the public network comprises remotely connecting to the dealer management system using an indirect connection that includes at least one intermediary device logically positioned between the remote system and the secure data access port.

12. The method of claim 1, wherein the secure data access port includes a board level computer, and the board level computer is operable to allow the remote system to remotely configure the secure data access port.

13. The method of claim 1, wherein identifying a dealer management system that is coupled to a secure data access port comprises identifying an automobile dealership's dealer management system.

14. A method for remotely collecting data from a dealer management system, comprising:
(a) remotely connecting to a dealer management system from a remote system coupled to the dealer management system over a public network, wherein the dealer management system includes stored dealer data;
(b) collecting a current set of data from the stored dealer data;
(c) comparing the current set of data with a previously collected set of data to determine if there are any differences between the sets of data;
(d) if there are differences between the sets of data:
replacing the previously collected set of data with the current set of data; and
updating a database with the identified differences in data, wherein the updated database includes collected data that is a near real-time replica of data stored in the dealer management system.

15. The method of claim 14, wherein remotely connecting to a dealer management system from a remote system coupled to the dealer management system over a public network comprises:
identifying a dealer management system that is coupled to a secure data access port, wherein the secure data access port is also coupled to a public network, and the dealer management system is coupled to at least one client device and is operable to process dealer initiated transactions from the client device; and
remotely connecting to the dealer management system from a remote system using the public network, wherein the remote connection is a public connection established through the secure data access port, and the secure data access port is operable to pass remote transactions received from the remote system to the dealer management system.

16. The method of claim 15, wherein the secure data access port collects the current set of data and the comparison between the current set of data and the previously collected set of data is performed by the secure data access port, and the secure data access port is operable to forward the identified differences in data to the remote system.

17. The method of claim 15, wherein collecting a current set of data from the stored dealer data comprises:
forwarding a remote transaction from the remote system to the dealer management system, wherein the remote transaction includes a request for stored data and is given a priority level by the dealer management system that is similar to client initiated transactions; and
receiving at the remote system the requested data from the dealer management system, wherein the requested data includes a current set of data from the stored dealer data.

18. The method of claim 17, further comprising:
in the secure data access port, transforming the remote transaction into a format that is acceptable for processing by the dealer management system, wherein the transformed transaction is in substantially the same format as client initiated transactions; and
in the secure data access port, transforming the requested data received from the dealer management system into a format acceptable for transmission over the public network.

19. The method of claim 18, wherein the requested data received from the dealer management system is transformed into data packets acceptable for transmission to the remote system using the TCP/IP protocol in an encrypted format.

20. The method of claim 15, wherein remotely connecting to the dealer management system from a remote system using the public network comprises remotely connecting to the dealer management system using the Internet by entering the IP address of the secure data access port.

21. The method of claim 15, wherein identifying a dealer management system that is coupled to a secure data access port comprises identifying an automobile dealership's dealer management system.

22. The method of claim 14, further comprising:
(e) repeating steps (b) through (d) on an adjustable interval of time that is adjustable to produce a desired resolution of current data stored in the database.

23. The method of claim 14, further comprising:
associating a timestamp with the collected current set of data, wherein the updated database includes the associated timestamp.

24. The method of claim 14, wherein updating a database with the identified differences in data comprises:
generating an update report that includes the identified differences between the sets of data; and
updating a database with the update report.

25. The method of claim 14, wherein the collected data stored in the database includes a plurality of data sets.

26. The method of claim 14, further comprising:
logging on to the dealer management system by providing a pass-code, wherein the pass-code provides file level access to certain data stored in the dealer management system, and the current set of data collected from the stored dealer data is directly accessed from the dealer management system.

27. A method for providing access to dealer data stored in a dealer management system, comprising:
entering into a service agreement with a customer interested in access to current dealer data;
arranging for the dealer data to be remotely collected from the dealer management system and stored in a remote facility using a public network; and
permitting the customer to access the remote facility to retrieve the stored dealer data.

28. The method of claim 27, wherein arranging for the dealer data to be remotely collected and stored in a remote facility using a public network comprises contracting with an operator of a data-warehouse to collect and store the dealer data from the dealer management system.

29. The method of claim 27, wherein arranging for the dealer data to be remotely collected and stored in a remote facility using a public network comprises configuring a remote system that is operable to:
(a) remotely connect to the dealer management system over a public network;
(b) collect a current set of data from the stored dealer data;
(c) compare the current set of data with a previously collected set of data to determine if there are any differences between the sets of data; and
(d) if there are differences between the sets of data:
replace the previously collected set of data with the current set of data; and
update a database with the identified differences in data, wherein the updated database includes collected data that is a near real-time replica of data stored in the dealer management system.

30. The method of claim 29, further comprising:
(e) repeat steps (b) through (d) on an adjustable interval of time that is adjustable to produce a desired resolution of current data stored in the database.

31. The method of claim 29, further comprising:
associating a timestamp with the collected current set of data, wherein the updated database includes the associated timestamp.

32. The method of claim 29, wherein the remote system remotely connects to the dealer management system over the public network by:
identifying a dealer management system that is coupled to a secure data access port, wherein the secure data access port is also coupled to the public network, and the dealer management system is coupled to at least one client device and is operable to process dealer initiated transactions from the client device; and
establishing a remote connection with the dealer management system, wherein the remote connection is a public connection established through the secure data access port, and the secure data access port is operable to pass remote transactions received from the remote system to the dealer management system.

33. The method of claim 32, wherein identifying a dealer management system that is coupled to a secure data access port comprises identifying an automobile dealership's dealer management system.

34. The method of claim 32, wherein the remote system collects a current set of data from the stored dealer data by:
forwarding a remote transaction from the remote system to the dealer management system, wherein the remote transaction includes a request for stored data and is given a priority level by the dealer management system that is similar to client initiated transactions; and
receiving at the remote system the requested data from the dealer management system, wherein the requested data includes the current set of data from the stored dealer data.

35. The method of claim 27, wherein the service agreement includes terms directed to the collection and availability of dealer data.

36. The method of claim 35, wherein the service agreement includes a collection interval for the dealer data, wherein the collection interval determines a data resolution for the collected data stored in the remote facility.

37. The method of claim 35, wherein the service agreement guarantees a minimum up-time that the customer is guaranteed access to the remote facility.

38. The method of claim 27, further comprising:
ensuring that the dealer data is made available to the customer at the agreed upon terms.

39. The method of claim 27, wherein arranging for the dealer data to be remotely collected and stored in a remote facility using a public network comprises configuring a remote system that is operable to:
(a) remotely connect to the dealer management system over a public network;
(b) collect a current set of data from the stored dealer data; and
(c) over-right an existing set of data stored in the remote facility with the current set of data.

40. The method of claim 39, further comprising:
(d) associating a timestamp with the collected current set of data, wherein the timestamp is retrievable from the remote facility to determine when the current set of data was last collected.

41. A system to facilitate the remote collection of data, comprising:
a secure data access port coupled to a public network and a dealer management system, wherein the dealer management system includes at least one client device and is operable to process dealer initiated transactions from the client device, wherein the secure data access port is cooperatively operable with the dealer management system to:
accept a remote connection from a remote system, wherein the remote connection is a public connection established with the secure data access port, and the secure data access port is operable to pass remote transactions received from the remote system to the dealer management system;
receive a remote transaction from the remote system and forward the remote transaction to the dealer management system, wherein the remote transaction includes a request for stored data and is given a priority level by the dealer management system that is similar to client initiated transactions; and
forward the requested data received from the dealer management system to the remote system.

42. The system of claim 41, wherein the secure data access port includes a board level computer, and the board level computer is operable to allow a remote system to remotely configure the secure data access port.

43. The system of claim 41, wherein the public network is the Internet and the secure data access port is assigned an IP address, and the remote connection between the remote system and the secure data access port is established by entering the IP address of the secure data access port.

44. The system of claim 41, wherein the secure data access port includes a security module that is operable to execute a security protocol that restricts access to the secure data access port, wherein the security protocol includes:
before accepting the remote connection, receiving a private key from the remote system; and
if the private key corresponds with a public key previously associated with the secure data access port, accepting the remote connection, otherwise the connection is denied.

45. The system of claim 41, wherein the secure data access port includes a security module that is operable to execute a security protocol that restricts access to the secure data access port, wherein the security protocol includes:
before accepting the remote connection, accepting an IP address of the remote system;
if the IP address corresponds with an accepted IP address, accepting the remote connection, otherwise the connection is denied.

46. The system of claim 41, wherein the secure data access port includes a security module that is operable to execute a security protocol that restricts access to the secure data access port, wherein the security protocol includes:
before accepting the remote connection, receiving a pass-code from the remote system; and
if the pass-code is determined to be a valid pass-code, accepting the remote connection, otherwise the connection is denied.

47. The system of claim 41, wherein the secure data access port is operable to:
transform the remote transaction into a format that is acceptable for processing by the dealer management system, wherein the transformed transaction is in substantially the same format as client initiated transactions; and
transform the requested data received from the dealer management system into a format acceptable for transmission over the public network.

48. The system of claim 47, wherein the requested data received from the dealer management system is transformed into data packets acceptable for transmission to the remote system using the TCP/IP protocol.

49. The system of claim 47, wherein the remote transaction received from the remote system is transformed into a serial data stream acceptable for transmission to the dealer management system.

50. The system of claim 41, wherein the secure data access port is coupled to a client device, and the secure data access port is operable to provide pass-through connectivity to the dealer management system for the client device, and the pass-through connectivity occurs transparent to the client device.

51. A system to facilitate the remote collection of data, comprising:
a dealer management system; and
a secure data access port coupled to a public network and a dealer management system, wherein the dealer management system includes at least one client device and is operable to process dealer initiated transactions from the client device, wherein the secure data access port is cooperatively operable with the dealer management system to:
accept a remote connection from a remote system, wherein the remote connection is established with the secure data access port, and the secure data access port is operable to pass remote transactions received from the remote system to the dealer management system;
receive a remote transaction from the remote system and forward the remote transaction to the dealer management system, wherein the remote transaction includes a request for stored data and is given a priority level by the dealer management system that is similar to client initiated transactions; and
forward the requested data received from the dealer management system to the remote system.

52. The system of claim 51, wherein the secure data access port includes a board level computer, and the board level computer is operable to allow a remote system to remotely configure the secure data access port.

53. The system of claim 51, wherein the dealer management system is an automobile dealership's dealer management system.

54. The system of claim 51, wherein the public network is the Internet and the secure data access port is assigned an IP address and the remote connection between the remote system and the secure data access port is established by entering the IP address of the secure data access port.

55. The system of claim 51, wherein the secure data access port includes a security module that is operable to execute a security protocol that restricts access to the secure data access port, wherein the security protocol includes:
before accepting the remote connection, receiving a private key from the remote system; and
if the private key corresponds with a public key previously associated with the secure data access port, accepting the remote connection, otherwise the connection is denied.

56. The system of claim 51, wherein the secure data access port includes a security module that is operable to execute a security protocol that restricts access to the secure data access port, wherein the security protocol includes:
before accepting the remote connection, accepting an IP address of the remote system;
if the IP address corresponds with an accepted IP address, accepting the remote connection, otherwise the connection is denied.

57. The system of claim 51, wherein the secure data access port includes a security module that is operable to execute a security protocol that restricts access to the secure data access port, wherein the security protocol includes:
before accepting the remote connection, receiving a pass-code from the remote system; and
if the pass-code is determined to be a valid pass-code, accepting the remote connection, otherwise the connection is denied.

58. The system of claim 51, wherein the secure data access port is operable to:
transform the remote transaction into a format that is acceptable for processing by the dealer management system, wherein the transformed transaction is in substantially the same format as client initiated transactions; and
transform the requested data received from the dealer management system into a format acceptable for transmission over the public network.

59. The system of claim 58, wherein the requested data received from the dealer management system is transformed into data packets acceptable for transmission to the remote system using the TCP/IP protocol.

60. The system of claim 58, wherein the remote transaction received from the remote system is transformed into a serial data stream acceptable for transmission to the dealer management system.
